(19) United States
(12) Patent Application Publication
(10) Pub. No.: US 2001/0049597 A1
(43) Pub. Date: Dec. 6, 2001

(54) Method and system for responding to a user based on a textual input

(76) Inventor: Matthew Klipstein, Encinitas, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/809,949

(22) Filed: Mar. 16, 2001

Related U.S. Application Data
(60) Provisional application No. 60/190,344, filed on Mar. 16, 2000.

(51) Int. Cl. G10L 19/00

(52) U.S. Cl. 704/200.1

(57) ABSTRACT

A method and system for analyzing a user's textual input and providing a natural language response based on content analysis of the user's input. The system and method converts output of a content analysis algorithm to generate a response that relates to a psychoanalytical category of a content analysis scale, such as anxiety, hostility, and many others. The method and system includes intelligent algorithms that simulate the response of a living counselor or therapist.

The benefit under 35 U.S.C. § 119(e) of the U.S. provisional application entitled METHOD AND SYSTEM FOR RESPONDING TO A USER BASED ON TEXTUAL INPUT, Ser. No. 60/190,344, filed Mar. 16, 2000, is hereby claimed.

BACKGROUND OF THE INVENTION

1. Field of the Invention

The invention relates generally to interactive computer systems. More particularly, this invention relates to a method and system for analyzing and responding to a user based on a textual input for psychological counseling.

2. Description of the Related Art

Many people desire or require the occasion to receive counsel from a trained psychiatrist or psychologist (“therapist”). However, several inhibiting factors may prevent a person from seeking counseling with a live therapist. These factors may include expense of the therapy, inhibitions about speaking with a therapist, discomfort with sharing personal experiences with a stranger, concerns about privacy, or other factors. It would be valuable to give these persons who might not otherwise seek out counsel a chance to seek it out by minimizing the contact with a real therapist.

In the field of psychology and, particularly, psychoanalysis, an individual may produce oral or written statements or narratives for delivery to and evaluation by a therapist. Using his or her expertise, the therapist may conduct a psychological evaluation of the individual based on these statements using various techniques. In doing this, the therapist may use a content analysis algorithm. As is well known, content analysis of language is a method of assessing what people say in speech or write about in text to determine how strongly they may feel about their subject matter. Generally, content analysis is quantitative since it is based on a tally of occurrences of particular words. It is desirable to choose a content analysis algorithm that evaluates materials containing not only conventional dictionary-defined words, but also idiomatic and slang expressions.

Content analysis software, such as the well known Gottschalk and Bechtel (“GB”) computerized algorithm of scoring based on the Gottschalk-Gleser (“G-G”) content analysis scales is available from GB Software of Corona del Mar, Calif., and is identified as the GB PCAD 2000 product. The GB software scores computer-readable transcriptions of verbal or written samples on several G-G content analysis scales to obtain an objective numerical scale for established psychological dimensions or factors (hereinafter “scales”). These scales, for example, include anxiety (including death, guilt, mutilation, separation, shame, and diffuse anxiety subscales), outward hostility (including overt hostility, covert hostility, and total outward hostility subscales), inward hostility, ambivalent hostility (i.e., hostility originating externally and directed towards the self), cognitive impairment, hope, depression (including seven subscales), and health/sickness.

Based on this algorithm, the GB software outputs quantitative scores for each of the content analysis scales. A therapist is then required to interpret these quantitative scores and provide a response to the individual. Although performing content analysis of statements from an individual reduces the interaction with the therapist, interaction is not eliminated completely. Also, a real time clinical assessment from the therapist is not provided. Some people may feel more comfortable eliminating the delay and the personal contact with the therapist entirely by accessing counseling through an interactive computer system instead.

Although interactive computer systems represent a considerable part of today's business world, they are somewhat limited in their uses. For example, interactive computer systems, such as kiosk systems for banks and other vendors, are commonly used to allow users to conduct banking or other transactions with little or no human intervention. These interactive computer systems, however, provide only a limited number of responses based on a predetermined and limited number of input options. More particularly, these interactive computer systems presently are limited in capability for receiving human input in the form of natural language and providing significant and varied responses to the input that is also in the form of natural language. Therefore, interactive computer systems have not been used to provide significant computer generated counseling responses to users that imitate responses from real or live persons.

Thus, there is a need in the psychoanalysis field for a computerized method and system that allow an individual to obtain computer-generated counseling based on the individual's textual input into the computer system. It is desirable to have the computer perform a content analysis of the textual input and convert or translate the results from the content analysis algorithms to provide appropriate responses to individuals seeking entertainment or therapy. The method and system should be adaptable to individual needs, and should provide customizable responses that simulate responses from an actual therapist.

### SUMMARY OF THE INVENTION

The invention provides a method and system for providing a psychoanalytical response to a user of a computer system based on the content analysis of the user's statements. In one embodiment, the method includes soliciting statements from the user over a network, entering the statements into a processor, and performing content analysis of the statements with a content analysis program to obtain scores on content analysis scales. The method further includes selecting a score that has the highest deviation from a predetermined normal level and associating the score having the highest deviation with one of a plurality of severity categories, wherein each severity category represents a level of deviation from the predetermined normal score on the content analysis scale. The method further includes retrieving a response to the statement that corresponds to the associated category from a database comprising a plurality of predetermined responses for each of the plurality of categories, wherein the response simulates a response from an actual therapist and providing the response to the user.

In another embodiment, the invention comprises a system for performing a psychoanalytical assessment of a user and responding to the user. The system includes a memory unit that is configured to store a list of predetermined responses, and an interface device for inputting statements from the user and displaying responses from the memory unit. The system also includes a server in communication with the memory unit and the interface device, wherein the server is configured to obtain statements from the input device and perform content analysis of the statements to obtain a psychoanalytical assessment of the statements. The server is further configured to associate scores of the content analysis with at least one of the responses stored in the memory unit. The server is further configured to provide the response to the interface device.

### BRIEF DESCRIPTION OF THE DRAWINGS

The above and other aspects, features, and advantages of the invention will be better understood by referring to the following detailed description, which should be read in conjunction with the accompanying drawings, in which:

FIG. 1 is a functional block diagram of a system for developing psychoanalytical responses to user input in accordance with one embodiment of the invention.

FIG. 2 is a flowchart describing the process of developing psychoanalytical responses using the system of FIG. 1.

FIG. 3 shows an exemplary portion of a database from which responses may be retrieved for a user.

### DETAILED DESCRIPTION OF THE INVENTION

The following description is not to be taken in a limiting sense, but is made merely for the purpose of describing the general principles of the invention. The scope of the invention should be determined with reference to the claims.

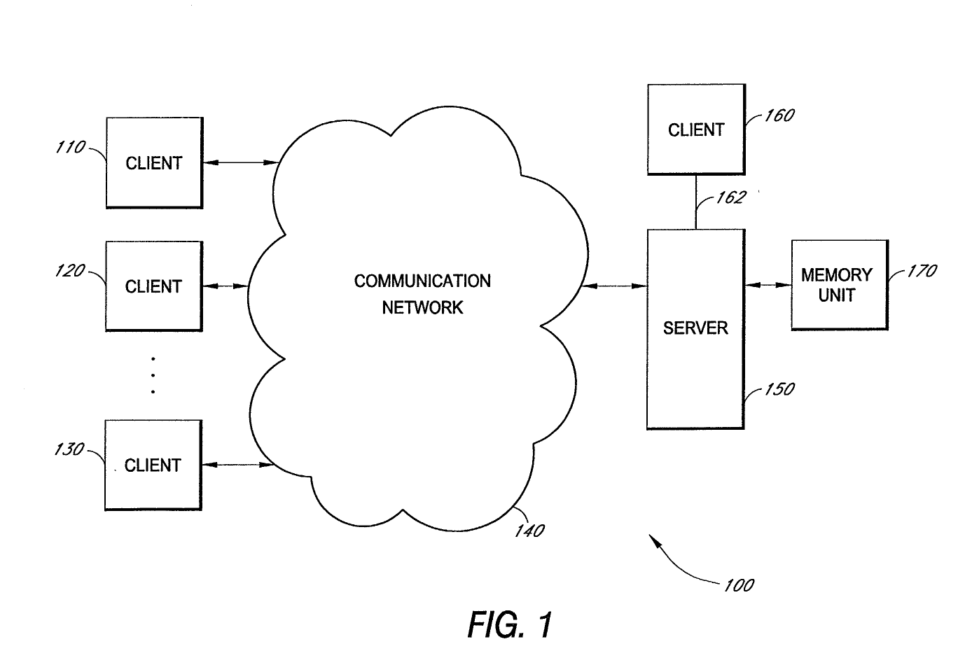

FIG. 1 is a functional block diagram of a system 100 for performing psychoanalytical assessment in accordance with one embodiment of the invention. The system 100 comprises a server computer 150 that includes or has access to a memory unit 170. The server 150 is configured to communicate with one or more client computers 110, 120, and 130 via a communication network 140, such as the Internet. Additionally, the server 150 can be configured to communicate with one or more client computers 160 via a dedicated or direct dial-up modem link 162. Generally, a client computer comprises a personal computer (PC) or workstation that is equipped with communication software, such as a web browser. For example, the communication software may include any commercially available web browser, such as Netscape Navigator or Microsoft Explorer, that communicates with the server 150.

The server 150 comprises at least one processor (not shown in this figure) that is programmed with instructions, such as computer firmware or software, that receive natural language input from a user, analyze content of such input, and provide a natural language response to the user. The server 150 is configured to retrieve and store information from and into the memory unit 170. Although only one memory unit 170 is shown in FIG. 1, it will be understood by one of ordinary skill in the art that the server 150 may include or have access to several memory units 170 to perform its functions, as further described below.

In one embodiment, a user may connect to the Internet via a client (e.g., the client 110) to access a web site (e.g., www.siggy.com) that is located at or accessible by the server 150. The server 150 is configured to obtain identification information from the user via the client 110 to authenticate the user. The identification information may include a usemame and password. Additional identification information may include age, gender, educational level, and other factors that may affect the complexity and quality of response by the server 150. Such additional information is typically entered when the user first signs up for service with the entity managing or controlling the server 150.

Once the user is authenticated, the server 150 directs the user to a dedicated interactive file, such as a web page of the user. The web page allows the user to enter any desired linguistic statements about any subject, thereby representing a personal journal entry. In one embodiment, it is desirable to adapt the server 150 to detect and respond to inputs from multiple languages, such as English, Spanish, French, and so forth. To increase the accuracy of content analysis, it is desirable to have the length of the user's journal entry exceed a selected level, such as 90 words, because the reliability of content analysis improves as the length of the journal entry increases. The user may input his or her entries into the client 110 using any desirable method, such as using a conventional keyboard or orally via a voice recognition application. The client 110 is configured to communicate the user's entries to the server 150 for content analysis and storage.

The server 150 is generally equipped or has access to content analysis software, such as the GB PCAD 2000 software program, that applies the G-G scales to machine-readable texts. The server 150 is configured to run the GB software to analyze the contents of the journal entry of the user. Based on this analysis, the GB software outputs quantitative scores for each of the content analysis scales. These quantitative scores are generally meaningless to a lay user and, thus, the server 150 is configured to convert or translate these scores into a meaningful assessment of the user's psychological state. Thus, in one embodiment, the server 150 is configured to categorize the resulting score for each content analysis scale (e.g., anxiety, hostility, etc.) into one of “N” categories, where N is any desired number of categories (e.g., 2, 3, 4, 5, etc . . . ). For example, when N is 3, the categories may be labeled as “High”, “Moderate”, and “Mild”. When N is 4, a fourth category, labeled “Extreme” can be added, and so forth. Thus, each category determines the severity of the score (e.g., extent of score deviation from a predetermined normal range) for each content analysis scale.

The purpose of categorizing each resulting score is to normalize the scores and, thus, determine which content analytical scale deserves or warrants a first response to the user. For example, if the anxiety score falls in the High category, whereas the hostility score falls in the Extreme category, the server 150 is configured to identify hostility as the category for immediate response, and save the anxiety category for a later response to the user. For each content analysis scale, and for each category of that scale, the server 150 stores a list of responses (e.g., 50 responses) that may be used in preparing a response to the user. Thus, when using four categories, the server 150 may store up to 200 (i.e., 50×4) responses for each content analysis scale. As indicated above, the type of responses stored for one category is commensurate with the severity of the category. Hence, responses for a High category are more extreme than responses for a Moderate category. Responses for the Moderate category are stronger than responses for a Mild category, and so forth. More details on this feature of the invention are presented below.

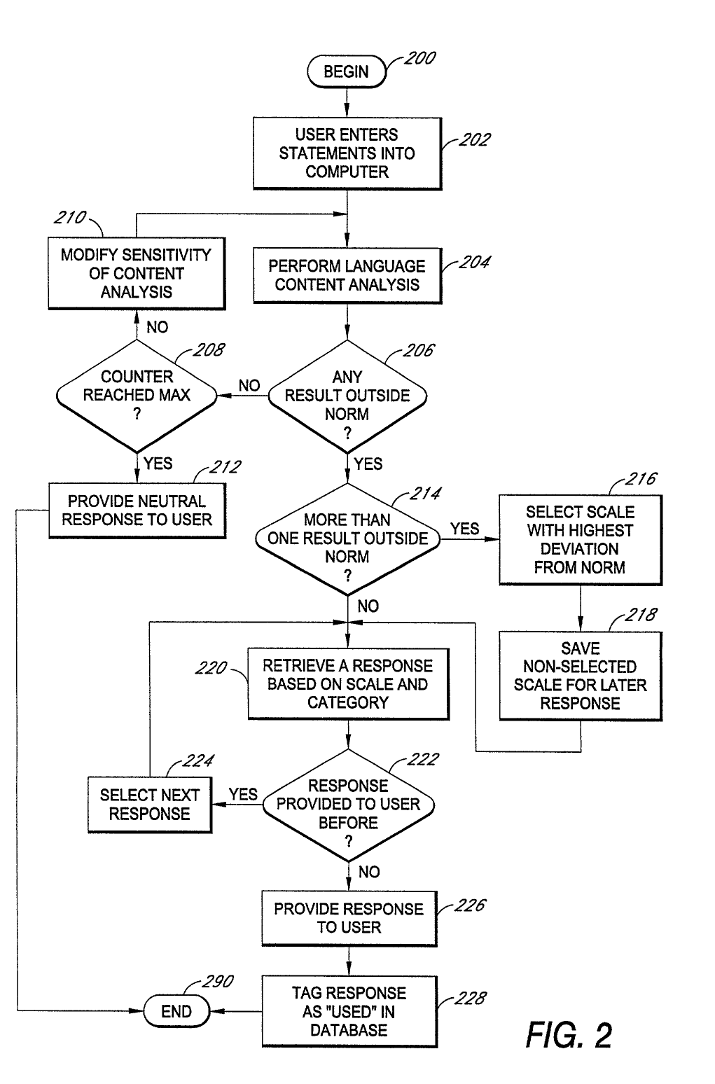

FIG. 2 is a flowchart describing the process of providing psychoanalytical responses in accordance with one embodiment of the invention. In this embodiment, the process typically begins at a block 200 when a user signs on and is authenticated by the web site of the server 150. For the purpose of the following description, it is assumed that a link is established between the user's client machine and the server 150, and that relevant information (e.g., age, gender, educational level, etc.) about the user was previously communicated to the server 150. At block 202, the user enters textual statements into the server 150 using a keyboard, or using any other data input method, such as a voice recognition application using a microphone. Once the statements are entered, the server 150 saves the statements for further processing. Thus, at block 204, the server 150 performs content analysis based on the user's statements using any commercially available content analysis software to obtain a psychoanalytical assessment of the statements. In one embodiment, the server 150 is configured to execute or run the commercially available GB PCAD 2000 software to produce quantitative scores for several content analysis scales.

As with most content analysis scales, the outcome of the content analysis for each scale may be classified as normal or abnormal (e.g., when a quantitative score for the scale is above or below a predetermined threshold value). Hence at block 206, the server 150 is configured to determine if any score of the scales falls outside the normal range. If none of the scores falls outside the normal range, the process continues to block 208 where the server 150 determines if a counter has reached a maximum value. The counter simply represents the number of times the content analysis software has produced scores within the normal range. The system administrator may set a maximum value (e.g., 3 times) for the number of times the process is configured to continue to block 210. At block 210, the server 150 may modify performance criteria of the content analysis software by increasing the sensitivity to the abnormal range for each scale. Effectively, the normal range of each scale is narrowed, so that a score that previously fell close to the edge of the normal range may now fall in an abnormal range. The process continues to block 204 where the server 150 runs the content analysis software using the modified sensitivity. If at block 208 the counter has reached a maximum, the process continues to block 212 where the server 150 is configured to provide a neutral response to the user indicating that the assessment is inconclusive or normal. Then, the process terminates at block 290.

On the other hand, if at block 206 the server 150 determines that there is at least one score that falls outside the normal range, the process continues to block 214 where the server determines whether more than one score falls outside the normal range. If the score for more than one scale is abnormal, the process continues to block 216 where the server 150 selects the scale having the highest deviation from its normal range. In the event that the scores of two or more scales have substantially equal deviation from their respective normal ranges, the server 150 simply selects one of those scales for response. The selection may be done randomly or with the use of any desired selection criteria. The process then continues to block 218 where the server saves the scores for other non-selected scales that fall outside the normal range. At a later time, e.g., the next time the user signs onto the server 150, the server 150 may provide the user with statements that are commensurate with the score of one of the saved scales. Such statements may be communicated to the user shortly after the user signs onto the server 150. This delayed response is intended to give the impression to the user that the server 150 is capable of detecting, remembering, and responding to the user about subtle psychoanalytical matters observed during a previous session between the user and the server 150.

At block 220, the server 150 is configured to obtain or retrieve a response from a database which contains a predetermined collection of responses for each category of each scale. The database may be an Oracle database residing in the memory unit 170 (see FIG. 1) or in any other accessible memory. As noted above, the server 150 categorizes the quantitative score for the selected scale in one of N (e.g., N=3) categories, each representing a level of severity of the score ranging from High to Mild. For each category, the database contains a predetermined list of responses (e.g., 50 responses) that are psychoanalytically appropriate for response to the user in that category. Thus, if the selected scale is hostility, and the hostility score of the user falls in the Mild category, the server 150 accesses the portion of the database for the Mild category of the hostility scale. At block 222, the server 150 determines whether the retrieved response was previously communicated to the user. It is desirable to avoid providing the same response to the same user more than once, thereby attributing the server 150 with some human-like characteristics. Thus, if the retrieved response was previously communicated to the user, the process continues to block 224 where the server selects the next response in the respective portion of the database. Because the list of responses in each category is relatively large (e.g., 50), it is unlikely that the list of responses will be exhausted in communication with the same user. If necessary, the system administrator may adjust the length of the list of responses based on historical experience with users. The process then returns to block 220.

If, on the other hand, it is determined in block 222 that the response was not previously communicated to the user, the process continues to block 226 where the server 150 provides the retrieved response to the user. Typically, the response to the user is provided in the form of a textual narrative about the psychological state of the user in connection with the content analysis scale having the score with the greatest deviation from normal range. At block 228, the server 150 labels the retrieved response as “used” to avoid using the same response for that user in the future. Thus, the server 150 may label the response in the database by associating it with user identification information. The process terminates at block 290.

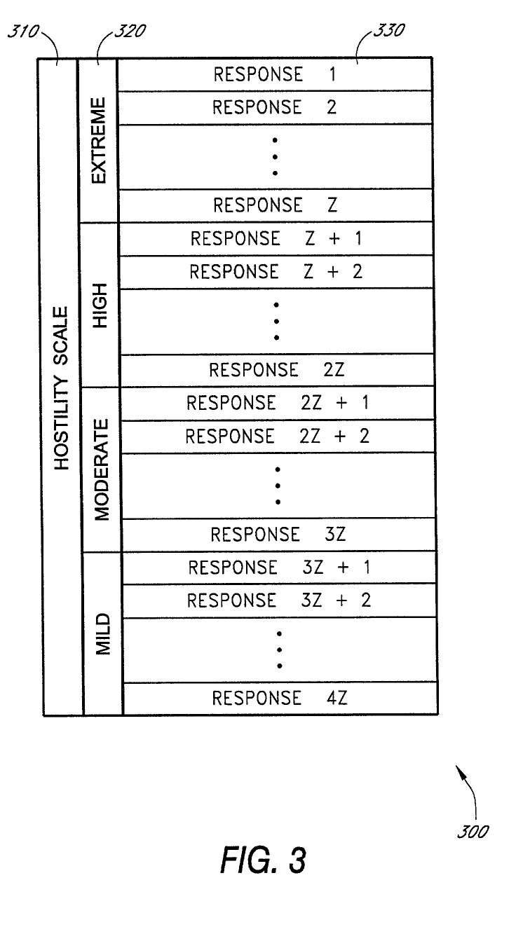

FIG. 3 is an exemplary portion of a database 300 from which responses may be retrieved for a user. The portion of the database 300 illustrates only a database section that relates to a single scale, e.g., hostility 310. As noted above, the entire database (not shown in this figure) comprises several portions or sections, each relating to one of the content analysis scales. As shown in FIG. 3, for each scale, the portion of the database 300 includes a plurality of categories 320. Each category 320 in the database contains a list of responses 330 that are commensurate with the severity of the category. Hence, responses for a High category are more extreme than responses for a Moderate category. Responses for the Moderate category are stronger than responses for a Mild category, and so forth.

For example, a mild response retrieved from the database 300 can be: “Feeling a little testy towards others, are we? So, all right, people can be a pain. But usually when we're irked at others, there's something being triggered in us that's more than just how the other is bugging us. You know, like they're reminding us of others way back that disappointed us. Or, underneath, they're hitting on some vulnerable spot in us . . . stuff like that. Any thoughts along these lines?”

A moderate response retrieved from the database 300 can be: “So what's this, do I detect some hostility here? You bet others can be a pain. But usually when our buttons get pushed, there's something underneath it that's adding voltage to our reactions—like the person reminds us of someone in our distant past that was threatening or disappointed us; or what bugs us about the person echoes something within ourselves that we don't like. Thoughts please . . . ”

A high response retrieved from the database 300 can be: “ANGERRRRR! Whoa, a lot going on here. Now, obviously you can just stay with your reaction and vent on. Or, if you're up for a little psycho-submarining, you could think about how all this connects with something way back that was threatening and painful to you. Now, if it feels like your feelings might move into actions, that would not be good for you or others. It would be important to talk to someone about all this—so here's a list of professionals in your area you could talk to (Click Here).”

The list of responses 330 includes multiple different responses in each category, for example from Response 1 to Response Z, where Z is the desired number of responses. Each response within the same category represents a variation of a similar psychoanalytical assessment in a form of a natural language response that is appropriate for a user whose hostility score falls in that category. Responses in the category 320 can be directed toward selected user groups based on identification information provided with the usemame and password. For example, response with slang or idiomatic expressions targeted toward a specific age brackets can have selection priority for a user in that age bracket. One skilled in the art will understand that there are various ways of selecting a response from the list of responses.

In view of the foregoing, it will be appreciated that the invention overcomes the long-standing need for a method and system that allow an individual to obtain simulated counseling based on the individual's textual input into a computer system. The invention may be embodied in other specific forms without departing from its spirit or essential characteristics. The described embodiment is to be considered in all respects only illustrative and not restrictive. The scope of the invention is, therefore, indicated by the appended claims rather by the foregoing description. All changes that fall within the meaning and range of equivalency of the claims are to be embraced within their scope.

What is claimed is:

1. A method of performing a psychoanalytical assessment and supplying a natural language response to a user, the method comprising:
receiving statements from the user;
performing content analysis of the statements to obtain a score on at least one content analysis scale;
associating the score to one of a plurality of categories, wherein each category represents a severity level of the score on the content analysis scale;
selecting a predetermined response that corresponds to the associated category from a database; and
providing the selected response to the user.

2. The method of claim 1, wherein the statements are received over a computer network.

3. The method of claim 1, wherein the statements contain at least 90 words.

4. The method of claim 1, wherein the statements are received in the form of a journal entry.

5. The method of claim 1, wherein the act of performing content analysis is performed by a content analysis program.

6. The method of claim 1, wherein the content analysis scales are selected from the group consisting of: anxiety, outward hostility, inward hostility, ambivalent hostility, cognitive impairment, hope, depression, and health/sickness.

7. The method of claim 1, wherein the plurality of categories comprises at least three categories.

8. The method of claim 7, wherein the categories include a mild category, a moderate category and a high category.

9. The method of claim 1, further including determining if the score exceeds a normal value.

10. The method of claim 1, wherein the response is selected from a database containing a plurality of responses corresponding to the associated category.

11. The method of claim 1, wherein the response simulates a response from a therapist.

12. A method of providing a psychoanalytical response to a user, the method comprising:
soliciting statements from the user over a network;
entering the statements into a processor;
performing content analysis of the statements with a content analysis program to obtain a plurality of scores on a plurality of content analysis scales;
associating at least one score with one of a plurality of categories, wherein each category represents a severity level of the score on the content analysis scale;
retrieving a response that corresponds to the associated category from a database comprising a plurality of predetermined responses for each of the plurality of categories, wherein the response simulates a response from an actual therapist; and
providing the response to the user.

13. The method of claim 12, further including selecting a score from the plurality of scores that has the highest deviation from a predetermined level.

14. The method of claim 12, wherein the scales are Gottschalk-Glesser content analysis scales.

15. The method of claim 12, wherein the solicited statements are provided from the user in the form of a journal entry.

16. The method of claim 12, wherein the network is the Internet.

17. The method of claim 12, wherein the program is GB PCAD 2000 software.

18. The method of claim 12, wherein the statements are entered using a keyboard.

19. The method of claim 12, wherein the statements are entered using voice recognition software.

20. A system for performing a psychoanalytical assessment of a user and providing a natural language response to the user comprising:
a memory unit configured to store a database containing a plurality of predetermined responses simulating advice from a therapist;
an interface device for inputting statements from the user and displaying responses retrieved from the memory unit;
a server in communication with the memory unit and the interface device, wherein the server is configured to obtain statements from the input device and perform content analysis of the statements to obtain at least one score for psychoanalytical assessment of the statements, and wherein the server is further configured to associate the at least one score of the content analysis with at least one of the responses stored in the memory unit and to provide the response to the interface device.

21. The system of claim 20, wherein the database of responses is categorized into a plurality of groups corresponding to content analysis scales, and each group is divided into a plurality of categories, wherein each category represents a severity level of the score of the content analysis.

22. The system of claim 21, wherein the plurality of categories comprise a high category, a moderate category, and a mild category.

23. The system of claim 20, wherein the interface device comprises a keyboard.

24. The system of claim 20, wherein the interface device comprises voice recognition software.

25. The system of claim 20, wherein the server uses a content analysis software program to perform the content analysis.

26. A system for performing a psychoanalytical assessment of a user and providing a natural language response to the user comprising:
a memory unit that is configured to store a database containing a plurality of predetermined responses;
an interface device for inputting statements from the user and displaying responses from the memory unit;
a server in communication with the memory unit and the interface device, the server configured to perform content analysis of the statements and determine a plurality of scores on a plurality of content analysis scales;
means for associating at least one of the plurality of scores with one of a plurality of categories, wherein each category represents a severity level of the score on the content analysis scale; and
means for selecting a response from the database that corresponds to the associated category.

27. The system of claim 26, wherein the server uses a content analysis software program to perform the content analysis.

28. The system of claim 26, further including means for selecting a score from the plurality of scores that has the highest deviation from a predetermined level.

29. The system of claim 26, wherein the plurality of categories comprise a high category, a moderate category, and a mild category.
